(19) United States
(12) Patent Application Publication
(10) Pub. No.: US 2025/0287233 A1
(43) Pub. Date: Sep. 11, 2025

(54) SYSTEM AND METHOD CONFIGURED TO PREDICT MODIFICATIONS TO COMMUNICATION TOWERS

(71) Applicant: DISH Wireless L.L.C., Englewood, CO (US)

(72) Inventor: Jon William Freeman Crofford, Denver, CO (US)

(73) Assignee: DISH Wireless L.L.C., Englewood, CO (US)

(21) Appl. No.: 18/597,617

(22) Filed: Mar. 6, 2024

(51) Int. Cl. H04W 24/08; H04W 24/02

(52) U.S. Cl. CPC H04W 24/08; H04W 24/02

(57) ABSTRACT

A system and method evaluate a communication tower for modification. The system includes a prediction module, a scoring module, and an output device. The prediction module receives asset data associated with the communication tower, and implements a prediction model to generate, from the asset data, a model probability score associated with the communication tower. The scoring module generates a tower modification recommendation from the model probability score. The output device outputs the tower modification recommendation. The system receives model training data for training the prediction model to implement a predictive regression model. The method implements the system.

### FIELD

The present disclosure relates generally to modifying communication towers, and, more particularly, to a system and method configured to predict modifications to communication towers.

### BACKGROUND

Communication networks utilize towers with antennas for the transmission, reception, and relaying of signals between communication devices, such as telephones, computers, and satellites. Such telephones include cellphones configured to perform telephonic operations and functions over a cellular network. As more and diverse communication devices are employed in a given network area, a configuration of hardware implementing the towers and the antennas must be modified to accommodate the expansion of a network to operate with the communication devices.

Typically, towers in a network area require hardware modifications for a variety of reasons, such as the age of the tower, the need to accommodate other antennas and other devices, and the need to meet any Federal Communications Commission (FCC) requirements. Such tower modifications involve adding structural elements such as steel-based beams and trusses to a given tower to improve a tower rating of the tower. The tower rating reflect the amount of loading of the tower, such as the amount of weight of the antennas and other equipment, the torque generated by additional antennas and equipment, and where the antennas and equipment are configured height-wise and direction-wise on the tower.

Owners of a tower often lease space on the tower to a tenant, such as a communication provider, for mounting and configuring antennas and other devices for use by the communication providers and associated subscribers of communication services. For example, although gimballed microwave antennas (GMA) are less expensive than other antennas, such GMA may have relatively lower quality. Also, SOMAX antennas may be relatively expensive, but have relatively high quality. Tower modifications include swapping out older or lesser quality antennas for newer or higher quality antennas. However, tower modifications typically incur significant expenses, such as the need of a communication provider to pay additional fees to the leasor in order to update the hardware of the communication provider on the site of the tower. Accordingly, a communication provider also needs to take into account such fees due to the leasor in addition to paying service fees to employ technicians to perform such tower modifications, as well as the cost of equipment and hardware improvements for the tower and the structures for mounting the antennas to the tower.

The determination of the need to perform tower modifications relies on the personal expertise of engineers using rules-of-thumb as well as subjective evaluations of the various factors involved in tower modifications. Some engineers who modify towers have low modification rates, such as an average rate of 7%. However, inefficiencies in processing the tower modification factors are based on insufficient knowledge of the towers, tower components, and tower-associated circumstances such as the location of the tower and the surrounding environment of the tower. Accordingly, some engineers with insufficient knowledge associated with the towers experience relatively high modification rates, such as rates as high as 40%.

Typically, when performing tower modifications such as subjectively selecting a site for a new tower or for adding or replacing an antenna or other equipment on an existing tower, engineers or others in an organization select the site, and send a team of workers to the site to perform the tower modification. However, due to such subjective selection of the site, the team of workers experience problems in implementing the modification at the site, resulting in cost inefficiencies, loss or waste of work time, and delays in implementing the modification.

### SUMMARY

According to an implementation consistent with the present disclosure, a system and method are configured to predict modifications to communication towers, which result in significant cost savings in performing objective evaluations of the various factors involved in tower modifications.

In an implementation, a modification evaluation system is configured to evaluate a communication tower for modification. The modification evaluation system comprises a hardware-based processor, a memory, a set of modules, and an output device. The memory is configured to store instructions and configured to provide the instructions to the hardware-based processor. The set of modules is configured to implement the instructions provided to the hardware-based processor. The set of modules includes a prediction module and a scoring module. The prediction module is configured to receive asset data associated with the communication tower, and to implement a prediction model, wherein the prediction model is configured to generate, from the asset data, a model probability score associated with the communication tower. The scoring module is configured to generate a tower modification recommendation from the model probability score. The output device is configured to output the tower modification recommendation.

In one or more implementations, the scoring module is configured to compare the model probability score to a predetermined notification threshold. In the case that the model probability score is greater than the predetermined notification threshold, the scoring module can generate the tower modification recommendation not recommending performance of a modification of the communication tower. In the case that the model probability score is less than or equal to the predetermined notification threshold, the scoring module can generate the tower modification recommendation recommending performance of the modification of the communication tower.

The asset data associated with the communication tower can be selected from the group consisting of: antenna characteristics, an age of the communication tower, environmental characteristics, a number of communication tenants associated with the communication tower, and location data of a geographic area surrounding the communication tower. The set of modules can include a preprocessing module configured to receive model training data, and to split the received model training data into initial model training data and testing data. In one or more implementations, the prediction module is configured to train the prediction model using the initial model training data. In certain implementations, the prediction module is configured, responsive to the testing data, to generate a first coefficient of determination. In the case that the first coefficient of determination is less than a predetermined testing threshold, the prediction module can retrain the trained prediction model until the prediction model generates a second coefficient of determination is greater than or equal to the predetermined testing threshold.

In one or more implementations, the prediction module, using the trained prediction model, is configured to generate, from the asset data, the model probability score associated with the communication tower. The prediction model can implement a predictive regression model. The predictive regression model can perform linear regression on the asset data to generate the model probability score associated with the communication tower.

In another implementation, a system is configured to evaluate a communication tower for modification, and comprises a model training data source, an asset database, and a modification evaluation sub-system. The model training data source is configured to store model training data. The assess database is configured to store asset data associated with the communication tower. The modification evaluation sub-system comprises a hardware-based processor, a memory, a set of modules, and an output device. The memory is configured to store instructions and configured to provide the instructions to the hardware-based processor. The set of modules is configured to implement the instructions provided to the hardware-based processor. The set of modules includes a prediction module and a scoring module. The prediction module is configured to receive the asset data, and to implement a prediction model, wherein the prediction model is configured to generate, from the asset data, a model probability score associated with the communication tower. The scoring module is configured to generate a tower modification recommendation from the model probability score. The output device is configured to output the tower modification recommendation.

In one or more implementations, the scoring module is configured to compare the model probability score to a predetermined notification threshold. In the case that the model probability score is greater than the predetermined notification threshold, the scoring module can generate the tower modification recommendation not recommending performance of a modification of the communication tower. In the case that the model probability score is less than or equal to the predetermined notification threshold, the scoring module can generate the tower modification recommendation recommending performance of the modification of the communication tower.

The asset data associated with the communication tower is selected from the group consisting of: antenna characteristics, an age of the communication tower, environmental characteristics, a number of communication tenants associated with the communication tower, and location data of a geographic area surrounding the communication tower. The set of modules can include a preprocessing module configured to receive model training data, and to split the received model training data into initial model training data and testing data. In certain implementations, the prediction module is configured to train the prediction model using the initial model training data.

In one or more implementations, the prediction module is configured, responsive to the testing data, to generate a first coefficient of determination. In the case that the first coefficient of determination is less than a predetermined testing threshold, the prediction module can retrain the trained prediction model until the prediction model generates a second coefficient of determination is greater than or equal to the predetermined testing threshold. In certain implementations, the prediction module, using the trained prediction model, is configured to generate, from the asset data, the model probability score associated with the communication tower. The prediction model can implement a predictive regression model. The predictive regression model can perform linear regression on the asset data to generate the model probability score associated with the communication tower.

In a further implementation, a computer-based method comprises providing a set of modules configured to implement instructions provided to a hardware-based processor, with the set of modules including a prediction module configured to implement a prediction model. The method further comprises receiving asset data associated with a communication tower, applying the asset data to the prediction model, and generating, from the asset data, a model probability score associated with the communication tower. The method further comprises generating a tower modification recommendation from the model probability score, and outputting the tower modification recommendation using an output device.

The method can further comprise, prior to receiving the asset data, receiving model training data, and prior to receiving the asset data, training the prediction model using the model training data. The prediction model can implement a predictive regression model. The predictive regression model can perform linear regression on the asset data to generate the model probability score associated with the communication tower.

Any combinations of the various embodiments, implementations, and examples disclosed herein can be used in a further implementation, consistent with the disclosure. These and other aspects and features can be appreciated from the following description of certain implementations presented herein in accordance with the disclosure and the accompanying drawings and claims.

### BRIEF DESCRIPTION OF THE DRAWINGS

FIG. 1 is a schematic of a system, according to an implementation.

FIG. 2 is a table of a data associated with a communication tower.

FIG. 3 is a schematic of a computing device used in the implementation of FIG. 1.

FIG. 4 is an example of computer code to perform linear regression.

FIG. 5 is an example table of modification probability scores and modification recommendations for towers.

FIGS. 6A-6B are a flowchart of operation of the system of FIG. 1.

It is noted that the drawings are illustrative and are not necessarily to scale.

### DETAILED DESCRIPTION

Example embodiments and implementations consistent with the teachings included in the present disclosure are directed to a system 100 and method 600 configured to predict modifications to communication towers.

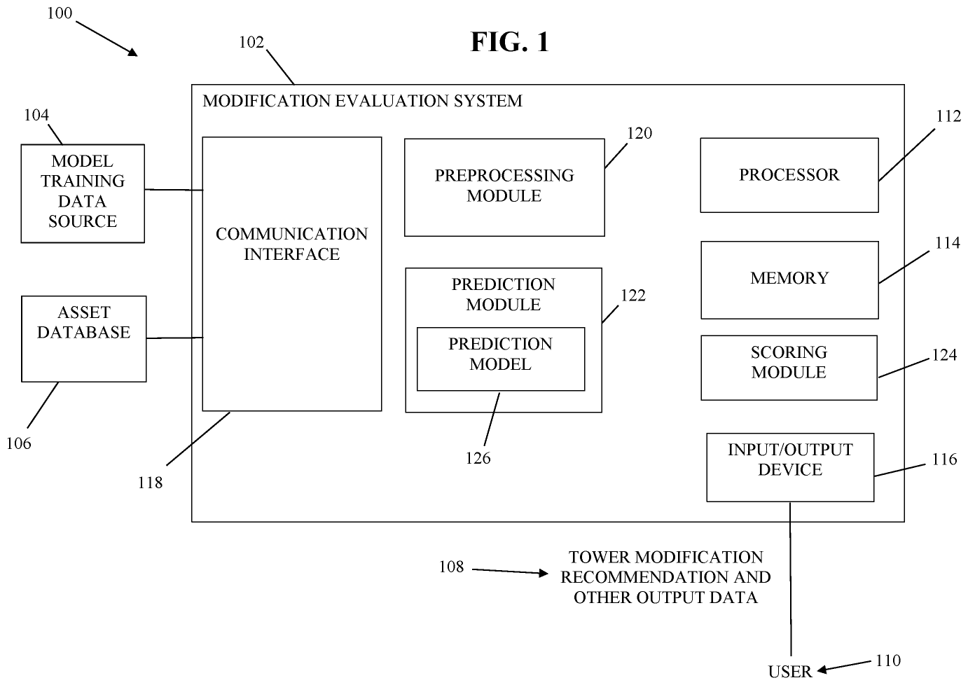

Referring to FIG. 1, the system 100 includes a modification evaluation system 102 configured to evaluate various factors and parameters associated with communication towers, and to predict modifications necessary for the communication towers, including evaluating modifications to existing towers, evaluating proposed or planned towers to be constructed, and evaluating the sites of proposed and existing towers. In one implementation, the modification evaluation system 102 is a sub-system of the system 100. The modification evaluation system 102 is operatively connected to a model training data source 104 and operatively connected to an asset database 106. The model training data source 104 stores or provides model training data configured to train a prediction model, as described in greater detail below. In one implementation, the model training data is stored or provided by the model training data source 104 in a predetermined data format. For example, the model training data is in a Structured Query Language (SQL)-based format, and the model training data source 104 is an SQL-based database storing the model training data. In another example, the model training data is in a text-format, such as an Extensible Markup Language (XML)-based format or a Standard Generalized Markup Language (SGML)-based format. In a further example, the model training data is stored in any known predetermined data format.

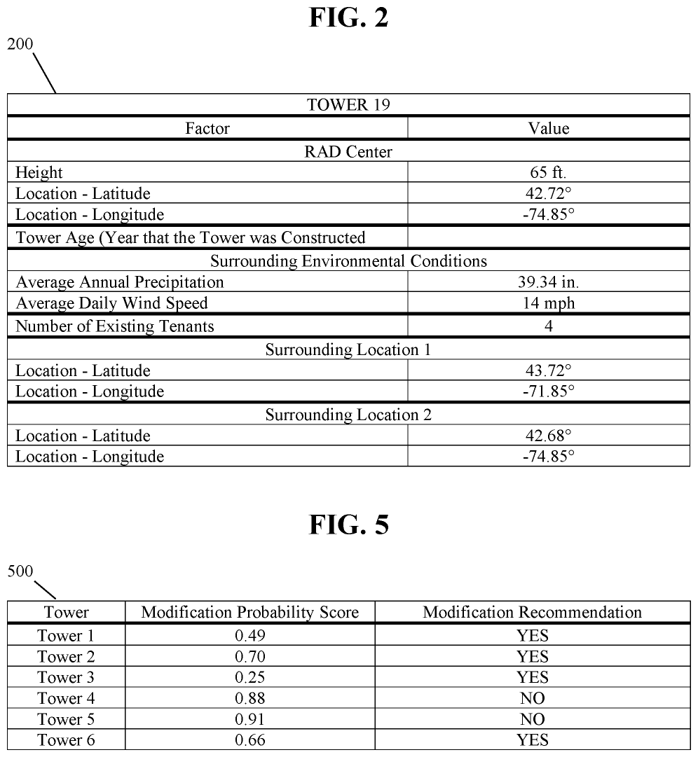

In one implementation, the model training data source 104 is a third-party or external source of model training data. In another implementation, the model training data source 104 is an external system, such as a server or other computing devices, configured to gather and store model training data. In an implementation, the model training data includes asset data, such as the example asset data 200 shown in FIG. 2, with a model probability score appended to the asset data. For example, a model probability score of 0.70 is associated with the asset data 200 and a tower specified in the asset data 200, and the model probability score of 0.70 is appended to the asset data 200 to be the model training data in the model training data source 104. As described in greater detail below, such a model probability score of 0.70 indicates to an engineer or an executive of an organization, such as a communication provider, whether to proceed with modification of a specific tower. For example, as described in greater detail below, a predetermined notification threshold determines whether the tower associated with the asset data 200 and the appended model probability score of 0.70 is to be modified or not.

The asset database 106 stores or provides an asset data associated with the communication provider utilizing at least one tower. For example, the asset data includes historical information about towers associated with the communication provider as well as previous hardware modifications of the towers. In another example, the asset data includes information about a RAD Center, which is a center of radiation of an antenna or other equipment on a tower, and which describes the center height of the antenna or equipment on the tower. For example, a communication provider or other organizations typically receive a license or a lease to occupy an area on the tower five feet below the RAD Center, which corresponds to an antenna base height, and five feet above the RAD Center, which corresponds to an antenna tip height.

In a further example, the asset data includes a primary tower site or location by latitude, and longitude, a tower age such as measured from the year that tower was constructed, surrounding environmental conditions such as weather or temperature, a number of existing tenants on the tower, and information on surrounding geographic locations associated with the tower. An example of asset data 200 is shown in FIG. 2, which lists various factors or parameters, and numerical values and units of the factors or parameters corresponding to a plurality of assets, such as communication towers and tower sites or locations. The example asset data 200 in FIG. 2 is associated with a tower labelled “TOWER 19”. The example asset data 200 includes RAD Center specifications, the tower age measured from the year that the tower was constructed, surrounding environmental conditions, the number of tenants using a particular tower, and the locations of various surroundings of various towers. In one implementation, the asset data, which is stored or provided by the asset database 106, is in a predetermined data format. For example, the asset data is in an SQL-based format, and the asset database is an SQL-based database storing the data. In another example, the asset data is in a text-format, such as an XML-based format or an SGML-based format. In a further example, the asset data is stored in any known predetermined data format. In one implementation, the asset database 106 is a third-party or external source of asset data. In another implementation, the asset database 106 is an external system, such as a server or other computing devices, configured to gather and store asset data.

In one implementation, the system 100 is operatively connected to the model training data source 104 and to the asset database 106 through a network. For example, the network is the Internet. In another example, the network is an internal network or intranet of an organization, such as a communication provider. In a further example, the network is a heterogeneous or hybrid network including the Internet and the intranet. In operation, the system 100 operates the modification evaluation system 102 to train the predication model using the model training data from the model training data source 104. The modification evaluation system 102 then receives asset data from the asset database 106, and processes the asset data using the trained prediction model to generate and output data 108 including a tower modification recommendation or to generate and output any other output data pertaining to tower modifications to a user 110.

For example, the user 110 is an engineer tasked to modify a selected existing tower using the tower modification recommendation or the other output data 108. For example, the engineer is a radio frequency (RF) engineer, an electrical engineer, or a civil engineer. In another example, the user 110 is an engineer tasked to evaluate a planned tower to be constructed. In a further example, the user 110 is an engineer tasked to evaluate a site or location of an existing tower to be modified, or a site or location of a planned tower to be constructed. In still another example, the user 110 is an executive of an organization, such as a communications provider, with the executive receiving the tower modification recommendation or the other output data 108, and then authorizing or not authorizing the modification of the selected tower, such as construction of a new tower or modification of an existing tower. Accordingly, the engineers of an organization are given a “go” or “no go” for constructing of a new tower or modifying an existing tower.

The modification evaluation system 102 includes a hardware-based processor 112, a memory 114 configured to store instructions and configured to provide the instructions to the hardware-based processor 112, an input/output device 116 configured to generate and output the tower modification recommendation and other output data 108 as described below, and a communication interface 118 operatively connected to the model training data source 104 and the asset database 106. The communication interface 118 is configured to receive the model training data and the asset data from the model training data source 104 and the asset database 106, respectively.

The modification evaluation system 102 also includes set of modules configured to implement the instructions provided to the hardware-based processor 112. The set of modules include a preprocessing module 120, a prediction module 122, and a scoring module 124. The predication module 122 includes a prediction model 126.

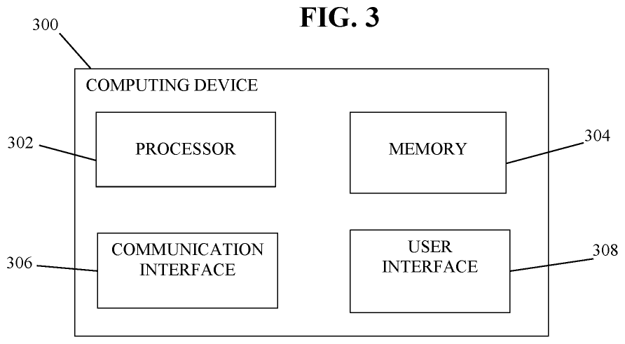

The modification evaluation system 102 is implemented by various computing devices, such as shown in FIG. 3. FIG. 3 illustrates a schematic of a computing device 300 including a processor 302 having code therein, a memory 304, and a communication interface 306. Optionally, the computing device 300 can include a user interface 308, such as an input device, an output device, or an input/output device. The processor 302, the memory 304, the communication interface 306, and the user interface 308 are operatively connected to each other via any known connections, such as a system bus, a network, etc. Any component, combination of components, and modules of the system 100 in FIG. 1 can be implemented by a respective computing device 300. For example, each of the components 102-106, 112-126 shown in FIG. 1 can be implemented by a respective computing device 300 shown in FIG. 3 and described below.

It is to be understood that the computing device 300 can include different components. Alternatively, the computing device 300 can include additional components. In another alternative implementation, some or all of the functions of a given component can instead be carried out by one or more different components. The computing device 300 can be implemented by a virtual computing device. Alternatively, the computing device 300 can be implemented by one or more computing resources in a cloud computing environment. Additionally, the computing device 300 can be implemented by a plurality of any known computing devices.

The processor 302 can be a hardware-based processor implementing a system, a sub-system, or a module. The processor 302 can include one or more general-purpose processors. Alternatively, the processor 302 can include one or more special-purpose processors. The processor 302 can be integrated in whole or in part with the memory 304, the communication interface 306, and the user interface 308. In another alternative implementation, the processor 302 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 302 can include a plurality of processing elements configured to perform parallel processing. In a further alternative implementation, the processor 302 can include a plurality of nodes or artificial neurons configured as an artificial neural network. The processor 302 can be configured to implement any known artificial neural network, including a convolutional neural network (CNN).

The memory 304 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The code of the processor 302 can be stored in a memory internal to the processor 302. The code can be instructions implemented in hardware. Alternatively, the code can be instructions implemented in software. The instructions can be machine-language instructions executable by the processor 302 to cause the computing device 300 to perform the functions of the computing device 300 described herein. Alternatively, the instructions can include script instructions executable by a script interpreter configured to cause the processor 302 and computing device 300 to execute the instructions specified in the script instructions. In another alternative implementation, the instructions are executable by the processor 302 to cause the computing device 300 to execute an artificial neural network. The processor 302 can be implemented using hardware or software, such as the code. The processor 302 can implement a system, a sub-system, or a module, as described herein.

The memory 304 can store data in any known format, such as databases, data structures, data lakes, or network parameters of a neural network. The data can be stored in a table, a flat file, data in a filesystem, a heap file, a B+ tree, a hash table, or a hash bucket. The memory 304 can be implemented by any known memory, including random access memory (RAM), cache memory, register memory, or any other known memory device configured to store instructions or data for rapid access by the processor 302, including storage of instructions during execution.

The communication interface 306 can be any known device configured to perform the communication interface functions of the computing device 300 described herein. The communication interface 306 can implement wired communication between the computing device 300 and another entity. Alternatively, the communication interface 306 can implement wireless communication between the computing device 300 and another entity. The communication interface 306 can be implemented by an Ethernet, Wi-Fi, Bluetooth, or USB interface. The communication interface 306 can transmit and receive data over a network and to other devices using any known communication link or communication protocol.

The user interface 308 can be any known device configured to perform user input and output functions. The user interface 308 can be configured to receive an input from a user. Alternatively, the user interface 308 can be configured to output information to the user. The user interface 308 can be a computer monitor, a television, a loudspeaker, a computer speaker, or any other known device operatively connected to the computing device 300 and configured to output information to the user. A user input can be received through the user interface 308 implementing a keyboard, a mouse, or any other known device operatively connected to the computing device 300 to input information from the user. Alternatively, the user interface 308 can be implemented by any known touchscreen. The computing device 300 can include a server, a personal computer, a laptop, a smartphone, or a tablet.

Referring to FIG. 1, the modification evaluation system 102, through the communication interface 118, receives the model training data from the model training data source 104. The memory 114 stores the received model training data. The preprocessing module 120 preprocesses the model training data to address missing values, outliers, and non-standardized data types in the model training data. There are multiple reasons why certain values are missing from the model training data. For example, past data is corrupted due to improper storage and maintenance of data structures. In another example, observations are not recorded for certain fields. In a further example, a failure occurs in recording the values due to human error. In an additional example, a user has not provided data values intentionally or unintentionally.

Regarding missing values, in one implementation, the preprocessing module 120 processes missing values using interpolation of data between multiple data points. In another implementation, the preprocessing module 120 processes missing values using extrapolation of data from multiple data points. Regarding outliers, in one implementation, the preprocessing module 120 removes an outlier from the model training data. In another implementation, the preprocessing module 120 generates an estimate of a data value based on other known data values, such as an estimated data value consistent with a trend of known data values. For example, linear regression is used to create a regression line from which an estimated data value is determined. The preprocessing module 120 then replaces the outlier using the estimated data value. Regarding non-standardized data types, the preprocessing module 120 converts all data values to be based in the same predetermined units. In one implementation, the preprocessing module 120 converts all length values to feet or miles. In another implementation, the preprocessing module 120 converts all length values to meters or kilometers. In a further implementation, the preprocessing module 102 converts all common parameters such as length, speed, humidity, temperature, etc. to be based in a predetermined unit or to conform to a predetermined system of units, such as the International System of Units (SI units), also known as the metric system.

Once the model training data is “cleaned” or preprocessed by the preprocessing module 120, the preprocessing module 120 splits the preprocessed received model training set into an initial model training data and testing data. In one implementation, the preprocessing module 120 splits the preprocessed model training data temporally; that is, the model training data is associated with timestamps indicating when the model training data was created or stored in the model training data source 104. For example, model training data is derived from asset data 200 in FIG. 2 with associated towers and associated modification probability scores, and also includes a timestamp. In an implementation, the preprocessing module 120 determines any model training data having a timestamp older than a predetermined date to be the initial model training data, and the preprocessing module 120 determines any model training data having a date stamp at or younger than the predetermined date to be the testing data. For example, the predetermined date is one year. In one implementation, the predetermined date is a default value stored in the memory 114. In another implementation, a system administrator, using the input/output device 116, sets or changes the predetermined date, and the set or changed predetermined date is stored in the memory 114. In a further implementation, the date stamp includes a date in a predetermined calendar system, such as the Gregorian calendar system. In another implementation, the date stamp includes a date and time in the predetermined calendar system.

In another implementation, the preprocessing module 120 splits the preprocessed model training data into the initial model training data and the testing data using any known data splitting method. After the splitting of the preprocessed model training data, the resultant initial model training data and the testing data are stored in the memory 114.

The prediction module 122 then trains the prediction model 126 using the initial model training data. In one implementation, the prediction module 122 trains the prediction model 126 using supervised learning. For example, the initial model training data includes input asset data associated with a tower, and the initial model training data includes a modification probability value associated with the input asset data. By supervised learning, the input asset data is applied to the prediction model being trained, which generates an initial output value. The initial output value is compared to the modification probability value as the desired output value, an error term is determined, and a configuration of the prediction model being trained is modified using the error term by known supervised learning methods to train the prediction model 126.

In another implementation, the prediction module 122 trains the prediction model 126 by adjusting hyperparameters determining hyperplanes generated from the initial model training data. Such adjustment of hyperparameters employs, for example, the method of ordinary least squares which computes the unique hyperplane that minimizes the sum of squared differences between the true initial model training data and the unique hyperplane. In a further implementation, the prediction module 122 trains the prediction model 126 using any known model training method.

After the initial model training data is used to train the prediction model 126 in the prediction module 122, the testing data is applied to the trained prediction model 126 to evaluate the performance of the trained prediction model on a data which is new or different from the model training data, the initial model training data, and the testing data. For example, the asset data from the asset database 106 is new or different data corresponding to changes in a tower and the factors or parameters associated with the tower, as shown in FIG. 2. In another example, the asset data from the asset database 106 include specifications of multiple towers, tower sites or locations, and operating characteristics of a network or cells in which the multiple towers operate.

The prediction module 122 stores, trains, and maintains the prediction model 126. In one implementation, the prediction model 126 includes a hardware-based artificial neural network including a plurality of nodes configured in a plurality of layers. In another implementation, the predication model 126 includes “pandas”, which is a software library, a set of high-performance computing (HPC) data structures, and data analysis and tools, implemented in hardware, and written for the PYTHON programming language for data manipulation and analysis of the asset data in the asset database 106 involving towers. Pandas are built around data structures called Series and DataFrames. For example, data for such collections of data structures are imported from various file formats such as comma-separated values, JSON, Parquet, SQL database tables or queries, and Microsoft Excel. In a further implementation, the prediction model 126 implements any known system, including artificial intelligence or machine learning, configured to be trained and to perform predictions of the tower modifications based on input asset data associated with towers as well as sites or locations of towers.

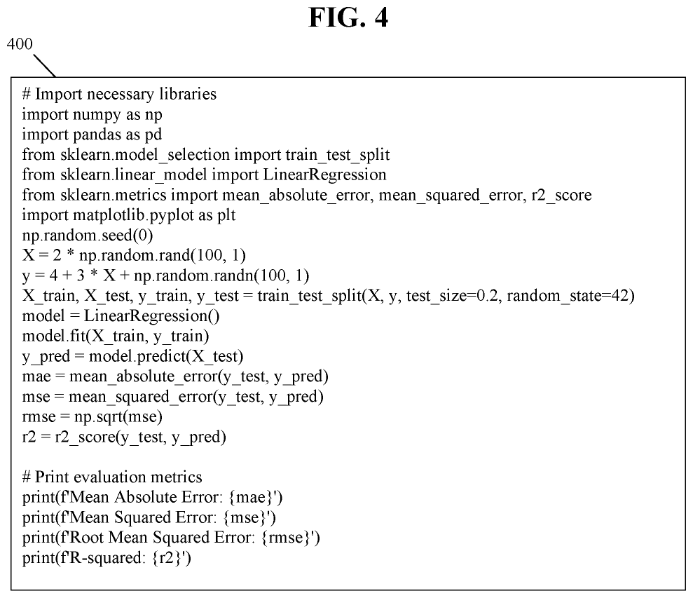

In one implementation, the prediction model 126 is a predictive regression model which is suitable for predicting the frequency of hardware modifications associated with the towers using the input asset data from the asset database 106. In one implementation, the predictive regression model as the prediction model 126 adjusts hyperparameters generated from the input asset data to optimize the performance of modifications of at least one tower. In another implementation, the predictive regression model, as the prediction model 126, performs linear regression on the input asset data. For example, the prediction module 122 executes computer code 400 as shown in FIG. 4 to perform linear regression on the input asset data. In one implementation, the computer code 400 is written in the PYTHON programming language. The prediction module 122 executes the PYTHON-based computer code using PYTHON libraries. In another implementation, the computer code 400 is written in any known programming language and using any known programming language libraries to be configured to perform linear regression on input asset data associated with at least one tower.

Once the prediction module 122 trains the prediction model 126 using the initial training data, the prediction module 122 applies the testing data to the prediction model 126 to evaluate the performance of the prediction model 126. In one implementation, the prediction model 126 generates an output data corresponding to the input testing data. In another implementation, the prediction model 126 also generates and outputs a coefficient of determination R², which is in the range from zero to one, inclusive.

During testing of the trained prediction model 126, in the case that the coefficient of determination R² is less than a predetermined testing threshold, the prediction module 122 retrains the prediction model 126 using new model training data. The coefficients of determination R² are in the range from zero to one, inclusive. In one implementation, the predetermined testing threshold is a relatively high number in the range from zero to one, inclusive. For example, the predetermined testing threshold is 0.70. In one implementation, the predetermined testing threshold is a default value stored in the memory 114. In another implementation, a system administrator, using the input/output device 116, sets or changes the predetermined testing threshold, and the set or changed predetermined testing threshold is stored in the memory 114.

In one implementation, the new model training data is generated by the prediction module 122 by combining the initial model training data with a portion of the testing data, while a remaining portion of the testing data is retained as new testing data to test the retrained prediction model 126. In another implementation, the new model training data is generated by the prediction module 122 by combining the initial model training data with all of the testing data to retrain the prediction model 126. In a further implementation, the prediction module 122 generates the new model training data by combining the initial model training data with asset data from the asset database 106.

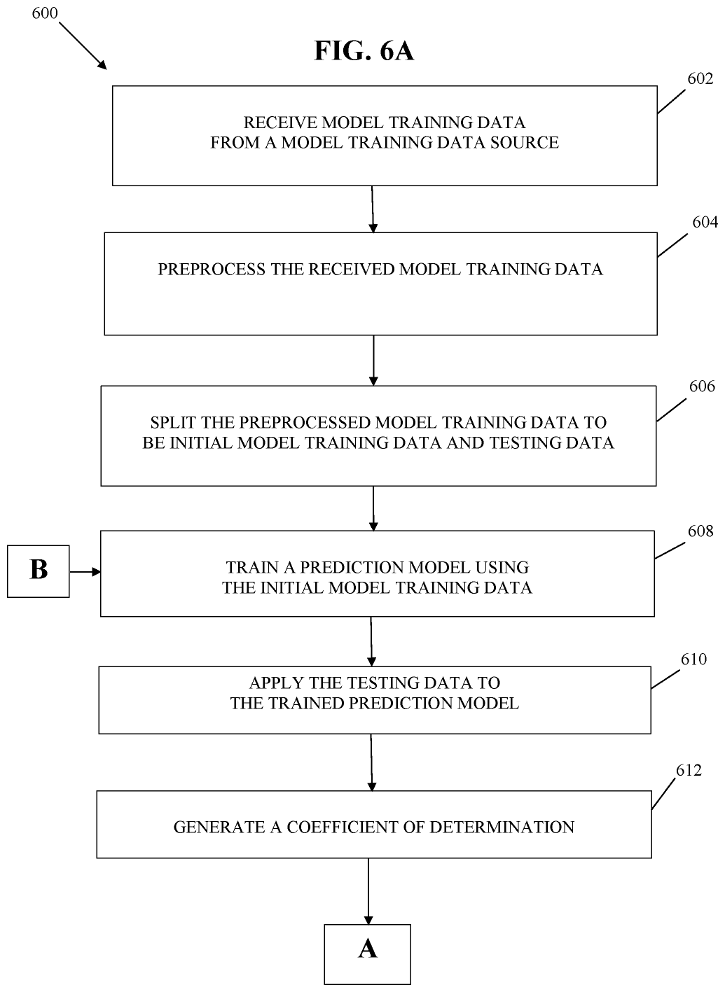

Once the prediction model 126 is trained, and optionally retrained, as described above, such that the coefficient of determination R² is greater than or equal to the predetermined testing threshold, the training process is completed, and the trained prediction model 126 processes the asset data from the asset database 106, and performs predictions of modifications of towers by generating the coefficient of determination R² for each tower. The coefficient of determination R² is designated to be a modification probability score of a tower, and the scoring module 124 associates each tower with its generated coefficient of determination R² as a modification probability score. For example, the scoring module 124 stores the modification probability scores in the memory 114, such as the example modification probability scores 500 shown in FIG. 5.

In one implementation, the modification probability scores are stored in a table in the memory 114, such as shown in FIG. 5. In another implementation, the modification probability scores are in a Structured Query Language (SQL)-based format, and the memory 114 stores the modification probability scores in an SQL-based database. In a further implementation, the modification probability scores are in a text-format, such as an Extensible Markup Language (XML)-based format or a Standard Generalized Markup Language (SGML)-based format to be stored in the memory 114. In a further example, the modification probability scores are stored in the memory 114 in any known predetermined data format. In an implementation, the scoring module 124 generates a data structure in the memory 114 and populates the data structure from the modification probability scores and from tower labels corresponding to the modification probability scores and designating the corresponding towers.

As new asset data corresponding to changes in the towers, network configurations, and surrounding locations is received and stored in the asset database 106, the new asset data is applied to the prediction model 126 to generate new coefficients of determination R² as modification probability scores of new or existing towers. Such newly generated modification probability scores of new or existing towers are associated with the new or existing towers by the scoring module 124 and stored in the data structures in the memory 114. In an implementation, the scoring module 124 populates the data structures with the new probability scores.

In one implementation, a modification probability score is associated with a tower, such as the modification probability scores and tower labels as shown in the table 500 in FIG. 5. In another implementation, the modification probability score is associated with a location of a primary tower among a set of towers. In a further implementation, the modification probability score is associated with a location of a primary tower as well as locations surrounding the primary tower. For example, such a modification probability score for a primary tower location and surrounding locations occurs when a primary tower services a cell in a cellphone network, and the locations surrounding the primary tower include other cell towers or other rooftop antennas.

Such modification probability scores associated with towers, as shown in FIG. 5, are output to a user 110 by the input/output device 116 as a tower modification recommendation or other output data 108. In one implementation, the input/output device 116 includes a display or monitor configured to visually display the modification probability scores associated with towers. For example, the display or monitor displays the table 500 in FIG. 5. In another example, the display or monitor displays a dashboard including the table 500 as well as other information, such as asset data 200 as shown in FIG. 2 and associated with towers and sites. In another implementation, the input/output device 116 includes a printer configured to physically print a hardcopy of the modification probability scores associated with towers for display or reading by a user 110. For example, the printer physically prints the table 500 in FIG. 5. In a further implementation, the input/output device 116 includes an audio speaker configured to audibly output the modification probability scores associated with towers as sounds, such as computer-generated speech.

In one implementation, the modification evaluation system 102 performs a prediction of the modification of a tower from the modification probability score which optimizes the configuration and performance of a network of towers based on predetermined criterion, such as cost efficiency resulting from performing the modification of a particular tower. Using the output modification probability score as output data 108 for a tower or a location to be the site of construction of a new tower, an engineer as the user 110 reprioritizes a market design using the modification probability score as a consideration or recommendation to determine which sites to build on, which towers to add components onto, or otherwise to modify existing towers and components on the towers such as antennas. In another implementation, the user 110 is an executive of an organization, such as a communications provider, with the executive receiving the tower modification recommendation or the other output data 108, and then authorizing or not authorizing the modification of the selected tower. Accordingly, based on the tower modification recommendation 108, the engineers of an organization are given a “go” or “no go” for constructing a new tower or modifying an existing tower.

In an implementation, towers with higher modification probability scores are given lower priority, since towers to be constructed or modified are likely to cost significantly more than other towers with lower modification probability scores. For example, in the case of a modification probability score or R² score of tower being equal to 0.70, such as for Tower 2 in FIG. 5, such a modification probability score indicates that, based on the attributes and other asset data of a site for a proposed tower or an existing tower, there is a very high likelihood that the site needs to be modified and an alternate candidate site for a proposed tower or modification of an existing tower should be used. In one implementation, the modification evaluation system 102 is configured to automatically generate a recommendation, an alert, or a notification to the user 110 indicating that the there is a very high likelihood that the site needs to be modified and an alternate candidate site for a proposed tower or modification of an existing tower should be used, based on the modification probability score being higher than a predetermined notification threshold.

For example, the predetermined notification threshold is set to 0.70, so that, for a tower having an associated modification probability score, the associated modification probability score greater than or equal to the notification threshold is flagged or used to automatically generate and output the recommendation, an alert, or a notification to the user 110. In one implementation, the modification evaluation system 102, responsive to the flagging of a modification probability score, automatically generates and outputs the recommendation, an alert, or a notification to the user 110 to indicate that modification of the existing tower or construction of a new tower at a site is not recommended to be done. In another implementation, the automatically generation and outputting of the recommendation, an alert, or a notification to the user 110 by the modification evaluation system 102 indicates to a user 110, such as an engineer, that modification of the existing tower or construction of a new tower should be redesigned in order to reduce the modification probability score of the redesigned tower below the predetermined notification threshold.

In another example, for each tower, an associated modification probability score less than the notification threshold is flagged or used to automatically generate and output a notification to the user 110, to indicate that modification of the existing tower or construction of a new tower at a site is recommended to be done. In one implementation, the predetermined notification threshold is a default value stored in the memory 114. In another implementation, a system administrator, using the input/output device 116, sets or changes the predetermined notification threshold, and the set or changed predetermined notification threshold is stored in the memory 114.

In an implementation, the predetermined notification threshold is equal to the predetermined testing threshold, described above. In an alternative implementation, the predetermined notification threshold is not equal to the predetermined testing threshold. Accordingly, the modification evaluation system 102 allows a system administrator or other users, such as project engineers or executives of an organization, to customize the determination of whether tower modifications are to be performed by setting a lower predetermined notification threshold. In an implementation consistent with the invention, such a customized lower predetermined notification threshold reflects a policy of an organization such as a communications provider to perform fewer tower modifications due to, for example, budget constraints. Such a lower predetermined notification threshold determines that towers with higher modification probability scores are given lower priority, since towers to be constructed or modified are likely to cost significantly more than other towers with lower modification probability scores. Accordingly, the priorities of modifying existing towers or constructing new towers allow the organization to operating efficiently within budget constraints.

In another implementation, the scoring module 124 generates and outputs a text message as the tower modification recommendation 108 of each tower based on the modification probability score of each tower, and whether the modification probability score is greater than the notification threshold or less than or equal to the notification threshold. For example, as shown in FIG. 5, the scoring module 124 populates the table 500 to include the text messages, such as “YES” or “NO”, indicating to the user 110 that the modification of a particular tower is recommended or not recommended. For example, with a notification threshold set to 0.70, Tower 1 has a “YES” recommendation since the associated modification probability score of 0.49 is less than or equal to 0.70. In another example, with a notification threshold set to 0.70, Tower 2 also has a “YES” recommendation since the associated modification probability score of 0.49 is less than or equal to 0.70. However, in a further example, with a notification threshold set to 0.70, Tower 4 has a “NO” recommendation since the associated modification probability score of 0.88 is greater than 0.70.

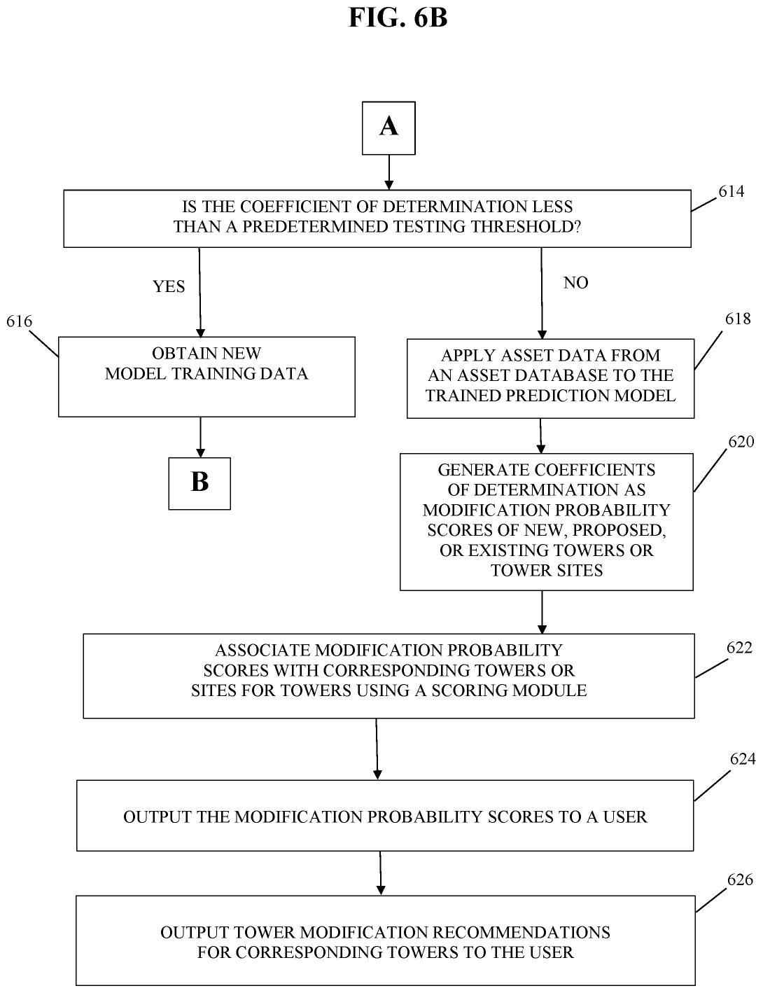

Referring to FIG. 6A-6B, a computer-based method 600 includes receiving model training data from a model training data source in step 602, preprocessing the received model training data in step 604, splitting the preprocessed model training data in step 606 to be initial model training data and testing data, and training a prediction model 126 in step 608 using the initial model training data. The method 600 then applies the testing data to the trained prediction model 126 in step 610, and generates a coefficient of determination in step 612. The method 600 then determines whether the coefficient of determination is less than a predetermined testing threshold in step 614. In the case that the coefficient of determination is less than the predetermined testing threshold in step 614, the method 600 obtains new model training data in step 616, and loops back to train the prediction model 126 in step 608 using the new model training data. The method 600 repeats steps 608-616 until the coefficient of determination generated from testing data is greater than or equal to the predetermined testing threshold in step 614.

In step 614, in the case that the method 600 determines a coefficient of determination to be greater than or equal to the predetermined testing threshold, the method 600 performs step 618 to apply the asset data from the asset database 106 to the trained prediction model 126, which generates coefficients of determination R² as modification probability scores of new, proposed, or existing towers or tower sites in step 620. The method 600 associates the modification probability scores with corresponding towers or sites for towers in step 622 using the scoring module 124, and the method 600 outputs the modification probability scores to the user 110 in step 624. In one implementation, the user 110 evaluates the modification probability scores to determine whether or not to proceed with a modification of the tower. Alternatively, the method 600 outputs a tower modification recommendation 108 to the user 110, such as the recommendations shown in FIG. 5, in step 626. As described above, the scoring module 124 generates and outputs a text message as the tower modification recommendation 108 of each tower based on the modification probability score of each tower.

In one implementation consistent with the invention, the system 100 and method 600 are also configured to evaluate a network of towers. Permutations of towers in a network and modifications of the towers among the permutations are assessed by the modification evaluation system 102 to optimize the performance of the network and efficiently modify the towers to achieve such optimization. For example, for towers labeled A, B, C, D, E, and F, the modification evaluation system 102 determines individual modification probabilities for the towers, such as 0.10, 0.25, 0.70, 0.49, 0.11, and 0.95, for towers A, B, C, D, E, and F, respectively. The modification evaluation system 102 then determines a permutation of towers such that a metric of the permutations, calculated from the individual modification probabilities, meets a predetermined criterion.

In one implementation, the scoring module 124 determines the metric for such permutations. For example, the predetermined criterion is a minimizing sum of the individual modification probabilities. For permutations of towers such as ABC, ABD, and BDF, the scoring module 124 determines the sums to be 1.05, 0.84, and 1.69 for permutations ABC, ABD, and BDF, respectively. In an implementation, the scoring module 124 indicates that the permutation ABD has a minimum sum, and so modifications to the towers A, B, and D are prioritized, since modification of such towers A, B, and D are most cost efficient than modification of other permutations of towers. In an alternative implementation, other predetermined criteria and other metrics are used to determine modifications of multiple towers optimizing the performance of the network of towers. For example, such optimization includes cost efficiency, prioritizing upgrades of older towers and equipment, and meeting a predetermined deadline for providing specific performance benchmarks. Such a predetermined deadline can be set by regulatory requirements on communication providers.

In another implementation, the system 100 and method 600 predict an optimized set of locations for placing towers as well as antennas and other equipment on the towers. In a further implementation, the system 100 and method 600 identify optimal configurations of existing tower sites based on antenna placement on towers, antenna propagation patterns, and antenna orientations. In still another implementation, the system 100 and method 600 provide an interactive approach for finding other antenna sites and orientations with optimal performance.

Portions of the methods described herein can be performed by software or firmware in machine readable form on a tangible or non-transitory storage medium. For example, the software or firmware can be in the form of a computer program including computer program code adapted to cause the system to perform various actions described herein when the program is run on a computer or suitable hardware device, and where the computer program can be implemented on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments, implementations, or arrangements.

The terminology used herein is for the purpose of describing particular implementations only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary implementations, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to implementations of the disclosure without departing from the essential scope thereof. Therefore, it is intended that the disclosure not be limited to the particular implementations disclosed, or to the best mode contemplated for carrying out this disclosure, but that the disclosure will include all implementations falling within the scope of the appended claims.

The subject matter described above is provided by way of illustration only and should not be construed as limiting. Various modifications and changes can be made to the subject matter described herein without following the example embodiments, implementations, and applications illustrated and described, and without departing from the true spirit and scope of the disclosure encompassed by the present disclosure, which is defined by the set of recitations in the following claims and by structures and functions or steps which are equivalent to these recitations.

What is claimed is:

1. A modification evaluation system configured to evaluate a communication tower for modification, comprising:
a hardware-based processor;
a memory configured to store instructions and configured to provide the instructions to the hardware-based processor;
a set of modules configured to implement the instructions provided to the hardware-based processor, the set of modules including:
a prediction module configured to receive asset data associated with the communication tower, and to implement a prediction model, wherein the prediction model is configured to generate, from the asset data, a model probability score associated with the communication tower; and
a scoring module configured to generate a tower modification recommendation from the model probability score; and
an output device configured to output the tower modification recommendation.

2. The modification evaluation system of claim 1, wherein the scoring module is configured to compare the model probability score to a predetermined notification threshold,
wherein, in the case that the model probability score is greater than the predetermined notification threshold, the scoring module generates the tower modification recommendation not recommending performance of a modification of the communication tower, and
wherein, in the case that the model probability score is less than or equal to the predetermined notification threshold, the scoring module generates the tower modification recommendation recommending performance of the modification of the communication tower.

3. The modification evaluation system of claim 1, wherein the asset data associated with the communication tower is selected from the group consisting of: antenna characteristics, an age of the communication tower, environmental characteristics, a number of communication tenants associated with the communication tower, and location data of a geographic area surrounding the communication tower.

4. The modification evaluation system of claim 1, wherein the set of modules includes a preprocessing module configured to receive model training data, and to split the received model training data into initial model training data and testing data, and
wherein the prediction module is configured to train the prediction model using the initial model training data.

5. The modification evaluation system of claim 4, wherein the prediction module is configured, responsive to the testing data, to generate a first coefficient of determination, and
wherein, in the case that the first coefficient of determination is less than a predetermined testing threshold, the prediction module retrains the trained prediction model until the prediction model generates a second coefficient of determination is greater than or equal to the predetermined testing threshold.

6. The modification evaluation system of claim 4, wherein the prediction module, using the trained prediction model, is configured to generate, from the asset data, the model probability score associated with the communication tower.

7. The modification evaluation system of claim 4, wherein the prediction model implements a predictive regression model.

8. The modification evaluation system of claim 7, wherein the predictive regression model performs linear regression on the asset data to generate the model probability score associated with the communication tower.

9. A system configured to evaluate a communication tower for modification, comprising:
a model training data source configured to store model training data;
an assess database configured to store asset data associated with the communication tower; and
a modification evaluation sub-system, comprising:
a hardware-based processor;
a memory configured to store instructions and configured to provide the instructions to the hardware-based processor;
a set of modules configured to implement the instructions provided to the hardware-based processor, the set of modules including:
a prediction module configured to receive the asset data, and to implement a prediction model, wherein the prediction model is configured to generate, from the asset data, a model probability score associated with the communication tower; and
a scoring module configured to generate a tower modification recommendation from the model probability score; and
an output device configured to output the tower modification recommendation.

10. The system of claim 9, wherein the scoring module is configured to compare the model probability score to a predetermined notification threshold,
wherein, in the case that the model probability score is greater than the predetermined notification threshold, the scoring module generates the tower modification recommendation not recommending performance of a modification of the communication tower, and
wherein, in the case that the model probability score is less than or equal to the predetermined notification threshold, the scoring module generates the tower modification recommendation recommending performance of the modification of the communication tower.

11. The system of claim 9, wherein the asset data associated with the communication tower is selected from the group consisting of: antenna characteristics, an age of the communication tower, environmental characteristics, a number of communication tenants associated with the communication tower, and location data of a geographic area surrounding the communication tower.

12. The system of claim 9, wherein the set of modules includes a preprocessing module configured to receive model training data, and to split the received model training data into initial model training data and testing data, and
wherein the prediction module is configured to train the prediction model using the initial model training data.

13. The system of claim 12, wherein the prediction module is configured, responsive to the testing data, to generate a first coefficient of determination, and
wherein, in the case that the first coefficient of determination is less than a predetermined testing threshold, the prediction module retrains the trained prediction model until the prediction model generates a second coefficient of determination is greater than or equal to the predetermined testing threshold.

14. The system of claim 12, wherein the prediction module, using the trained prediction model, is configured to generate, from the asset data, the model probability score associated with the communication tower.

15. The system of claim 12, wherein the prediction model implements a predictive regression model.

16. The system of claim 15, wherein the predictive regression model performs linear regression on the asset data to generate the model probability score associated with the communication tower.

17. A computer-based method, comprising:
providing a set of modules configured to implement instructions provided to a hardware-based processor, the set of modules including:
a prediction module configured to implement a prediction model;
receiving asset data associated with a communication tower;
applying the asset data to the prediction model;
generating, from the asset data, a model probability score associated with the communication tower;
generating a tower modification recommendation from the model probability score; and
outputting, using an output device, the tower modification recommendation.

18. The computer-based method of claim 17, further comprising:
prior to receiving the asset data, receiving model training data; and
prior to receiving the asset data, training the prediction model using the model training data.

19. The computer-based method of claim 17, wherein the prediction model implements a predictive regression model.

20. The computer-based method of claim 19, wherein the predictive regression model performs linear regression on the asset data to generate the model probability score associated with the communication tower.
